(19) United States
(12) Patent Application Publication
(10) Pub. No.: US 2025/0087024 A1
(43) Pub. Date: Mar. 13, 2025

(54) APPARATUS AND METHOD FOR MONITORING CHILD BEHAVIOR

(71) Applicant: LumanLab Inc., Sejong-si (KR)

(72) Inventor: Jae Hyun LIM, Seoul (KR)

(21) Appl. No.: 18/817,229

(22) Filed: Aug. 28, 2024

(30) Foreign Application Priority Data
Sep. 13, 2023 (KR) 10-2023-0121655

(51) Int. Cl. G06V 40/20; G06T 7/70; G06V 10/764; G06V 10/82; G06V 20/40; G06V 20/52; G06V 40/16

(52) U.S. Cl. CPC G06V 40/20; G06T 7/70; G06V 10/764; G06V 10/82; G06V 20/41; G06V 20/52; G06V 40/172; G06T 2207/10016; G06T 2207/20084; G06T 2207/30201

(57) ABSTRACT

The present disclosure discloses a child behavior monitoring apparatus and method allowing detecting dangerous situations and acquiring behavior analysis data using artificial neural networks. According to an embodiment, a monitoring apparatus includes an object detection unit configured to receive video data generated from one or more cameras and to detect one or more persons included in each piece of video data; a behavior detection unit configured to analyze behaviors of each of the one or more detected persons based on the video data and the detection result to generate behavior type data; and a data transmission unit configured to transmit monitoring data to one or more predetermined users according to specified criteria based on the behavior type data.

### CROSS REFERENCE TO RELATED APPLICATION

This application claims the benefit of and priority to Korea Patent Application No. 10-2023-0121655, filed on Sep. 13, 2023, the entire disclosure(s) of which is hereby incorporated herein by reference in its entirety.

### FIELD OF TECHNOLOGY

The present disclosure relates to monitoring technology, and more particularly, to an apparatus and method for monitoring child behavior that can detect dangerous situations and acquire behavioral analysis data using artificial neural networks.

### BACKGROUND

Recently, object detection technology using artificial neural networks has been actively developed. Object detection is a technique used in the fields of image processing or computer vision. Various approaches can be used for object detection, and machine learning and deep learning technologies are widely adopted recently for object detection. Deep learning technology, which is extensively used for object detection, employs models such as Convolutional Neural Networks (CNN) that automatically learn unique features of objects to identify the objects. Machine learning technology provides a different approach compared to deep learning.

Korean Patent Registration No. 10-2394509 discloses a method for real-time monitoring of a child's activity using facial detection technology.

### SUMMARY

The present disclosure is to provide an apparatus and method for monitoring child behavior that allow detecting dangerous situations and obtaining behavioral analysis data using artificial neural networks.

According to one aspect, the present disclosure provides a monitoring apparatus including: an object detection unit to receive video data generated from one or more cameras and detect one or more persons included in each piece of video data; a behavior detection unit to analyze behaviors of each detected person based on the video data and the detection result to generate behavior type data; and a data transmission unit to transmit monitoring data to one or more predetermined users according to specified criteria based on the behavior type data.

The object detection unit may generate coordinate data of one or more persons included in the video data using a first artificial neural network trained to classify a person as an object and detect the location of the object. It may also generate identity data for each person detected as an object using a second artificial neural network trained to recognize the face of the person and identify the identity.

The object detection unit may extract images of the person classified as an object based on the coordinate data of one or more persons included in the video data to generate detection target data, and generate identity data of the person included in the detection target data by inputting the detection target data into the second artificial neural network.

The object detection unit may generate location data by calculating the locations of one or more persons based on the location information of the one or more cameras and the coordinate data of one or more persons included in the video data. If the persons are detected at the same location in the video data captured by multiple cameras, it may determine the persons as one single person, and determine the identity of this one single person by merging multiple pieces of identity data generated from the video data captured by the multiple cameras for the persons determined as one single person.

The behavior detection unit may include a third artificial neural network trained to classify behaviors of persons included in the video data into predetermined types, and it may generate behavior type data for a person included in the detection target data based on the detection target data and identity data using the third artificial neural network.

The behavior detection unit may generate behavior type data for one single person by merging two or more pieces of behavior type data for the one single person captured by multiple cameras.

The behavior detection unit may analyze at least one of the number of occurrences, occurrence cycle, and duration of a specific behavior within a predetermined time based on the behavior type data over time by identity, and further include abnormality repetition data in the behavior type data if any behaviors exceeding a predetermined criterion for each behavior type are detected.

The behavior detection unit may analyze the identity of other persons within a predetermined distance during a specific behavior based on the behavior type data over time by identity and the location data over time by identity, and, if any behavior exceeding a predetermined criterion for each behavior type is detected in relation to a person with a specific identity, it may further include abnormal relationship data in the behavior type data.

When a specific type of behavior is detected based on the behavior type data, the behavior detection unit may store video data of a predetermined time period based on the detection time.

According to one aspect, the present disclosure provides a monitoring method including: an object detection step of receiving video data generated from one or more cameras and detecting one or more persons included in each piece of video data; a behavior detection step of analyzing behaviors of each detected person based on the video data and the detection result to generate behavior type data; and a data transmission step of transmitting monitoring data to one or more users predesignated according to specified criteria based on the behavior type data.

The monitoring apparatus according to one aspect of the present disclosure supports the assessment of a child's ‘sociability’ based on monitoring information for the child. When it is determined that the child's current situation is ‘dangerous’, a warning process, such as notifying childcare facility managers (teachers, etc.) can be performed.

Furthermore, the child's monitoring data can be provided to medical professionals for additional education and treatment for the child.

### BRIEF DESCRIPTION OF THE DRAWINGS

In order that the disclosure may be well understood, there are now described various forms thereof, given by way of example, reference being made to the accompanying drawings, in which:

FIG. 1 is a configuration diagram of a monitoring apparatus according to an exemplary embodiment;

FIG. 2 is an exemplary diagram illustrating operating environment of a monitoring apparatus according to an exemplary embodiment;

FIG. 3 is a configuration diagram of an object detection unit according to an exemplary embodiment;

FIG. 4 is an exemplary diagram illustrating detection target data according to an example;

FIG. 5 is a configuration diagram of a behavior detection unit according to an exemplary embodiment; and

FIG. 6 is a flow diagram illustrating a monitoring method according to an exemplary embodiment.

### DETAILED DESCRIPTION OF EXEMPLARY EMBODIMENTS

Hereinafter, an embodiment of the present disclosure will be described in detail with reference to the accompanying drawings. In describing the present disclosure, specific descriptions of related known functions or configurations will be omitted if it is determined that they may unnecessarily obscure the gist of the present disclosure. Additionally, the terms to be described below are defined in consideration of the functions in the present disclosure, and may vary depending on the intentions or practices of users or operators. Therefore, their definitions should be made based on the overall content of this specification.

Hereinafter, embodiments of a monitoring apparatus and method will be described in detail with reference to the drawings.

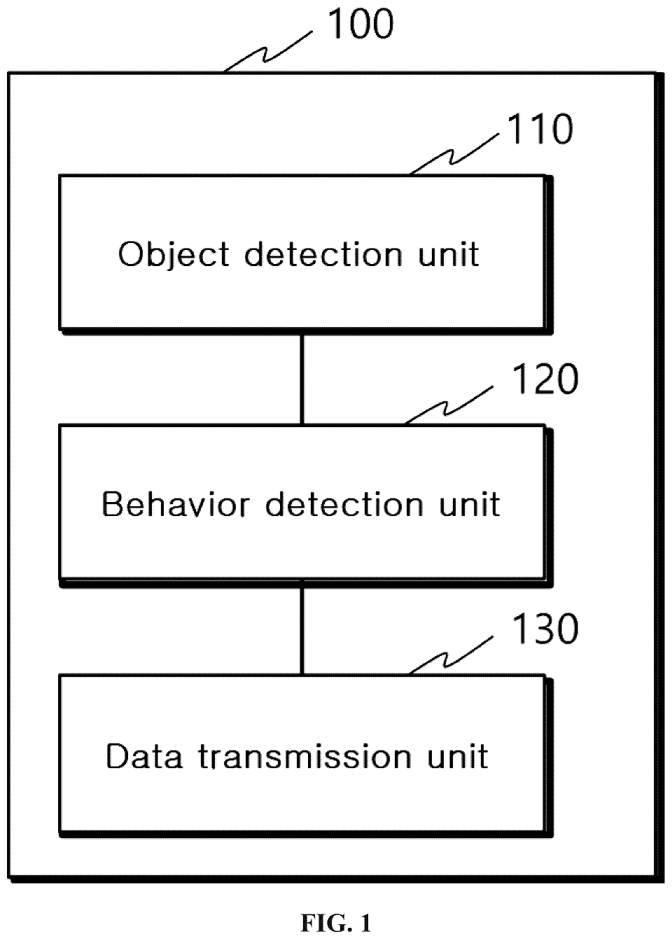

FIG. 1 is a configuration diagram of a monitoring apparatus according to an embodiment.

For example, the monitoring apparatus may acquire monitoring data of a child and analyze the acquired monitoring data to determine problematic situations based on scenarios for a specific child. Additionally, the monitoring apparatus may cluster and store monitoring data related to problematic situations. When a specific child's situation is deemed “dangerous,” the monitoring apparatus may perform a warning process to share the data with some or all childcare facility managers (teachers, etc.), child guardians, and medical professionals (who would diagnose the child's health condition).

The monitoring apparatus may, in real time, identify specific moments conforming to a predetermined “problem situation scenario” based on an artificial neural network during the process of acquiring the child's monitoring data. Here, the “problem situation scenario” may be pre-designed and categorized into immediate or short-term determination scenarios and long-term determination scenarios.

According to one example, an object detection unit 110 may verify the consistency of objects extracted by two or more cameras. For instance, the object detection unit 110 may assign relative coordinates to each object based on images captured by each of the two or more cameras. For example, the top left corner of an image captured by Camera 1 may be set as coordinates (0,0), and coordinates of User 1, whose center is at position horizontally distanced by a and longitudinally distanced by b from (0,0), may be set as (a,b). Subsequently, the object detection unit 110 may set coordinates of User 2, who is horizontally distanced by k from User 1, as (a-k, b). The object detection unit 110 may determine the accuracy of the coordinates of User 2by comparing it with coordinates (a′, b′), which is calculated in the same method as that for assigning the coordinates of User 1.

For example, when a person corresponding to User 1 is captured also by Camera 2, the object detection unit 110 can calculate coordinates (c, d) for that person. That is, when a specific user with coordinates (c, d) is identified in video data from Camera 2, the object detection unit 110 may confirm that this user is the same person as User 1 captured by Camera 1.

For example, the object detection unit 110 may have the following parameters for each of the multiple cameras. Additionally, the object detection unit 110 may correct the parameters according to changes in camera's shooting angles and calculate coordinates by referring to some of these parameters. For instance, the parameters may include a camera shooting angle (α) relative to the horizontal, a distance difference from Camera 1 (horizontal, vertical), a height difference (h), an angle difference (θ) of a shooting axis, a shooting image size difference, a correction value for lens distortion (required to predict coordinates in a final image of which distortion has been corrected), etc.

For example, when using three-dimensional coordinates, depth may be considered for an additional dimensional coordinate. That is, for an object with coordinates (a, b), a depth, that is, a distance from the camera, may be calculated and coordinates in a form of (a, b, depth) may be assigned.

According to one example, the object detection unit 110 may divide a target space into segments and set absolute coordinates corresponding to the real-world coordinate system. For instance, in a case when processing the target space to be a 2D image, the object detection unit 110 may divide the space into predetermined segments of ‘width×height’, and in a case when processing it to be a 3D image, it may divide the space into segments of ‘width×height×depth’, so that the space may be divided into multiple subspaces. Subsequently, the object detection unit 110 may set absolute coordinates for each of the subspaces based on the real-world coordinate system. For example, coordinates for a specific space, like GPS coordinates, may be set.

For example, when extracting human objects from video data of each camera and assigning coordinates for the objects, the object detection unit 110 may assign absolute coordinates by referring to absolute coordinate information of a subspace corresponding to the respective objects. The object detection unit 110 may compare the absolute coordinates of the respective objects extracted from multiple cameras and determine whether these objects are one same person.

According to one embodiment, the object detection unit 110 may include a first artificial neural network 111 trained to classify persons as objects and detect locations of the objects. For example, for the first artificial neural network 111, a convolutional neural network (CNN) or a neural network such as You Only Look Once (YOLO) may be used for object detection. The first artificial neural network 111 may receive video data, detect persons included in the video data, generate coordinate information by extracting coordinates of the detected persons or generate bounding boxes respectively for areas including the persons.

For example, the first artificial neural network 111 may generate coordinate data of one or more persons included in the video data. For instance, the coordinate data may include coordinates of a predetermined corner of each bounding box and coordinates of the diagonally opposite corner. In another example, the coordinate data may include coordinates of a predetermined corner of each bounding box, the horizontal length of the bounding box, and the longitudinal length of the bounding box.

According to one embodiment, the object detection unit 110 may include a second artificial neural network 113 trained to recognize a person's face and identify the identity. For example, the second artificial neural network 113 may be trained to recognize a face of a person included in input images based on training data including images containing persons' faces and identification information, and to output at least one of identification probabilities and identification information. For instance, the second artificial neural network may output identification probabilities such as ‘User 1=55%, User 2=12%, User 3=82%’. In another example, the second artificial neural network may output, as identification information, a user with the highest probability after calculating the identification probabilities, ‘User 1=55%, User 2=12%, User 3=82%’.

Here, the second artificial neural network 113 may be trained by comparing the identification information included in the training data as correct values with output identification information.

According to one embodiment, the object detection unit 110 may generate identity data for each of the one or more persons detected as objects using the second artificial neural network 113.

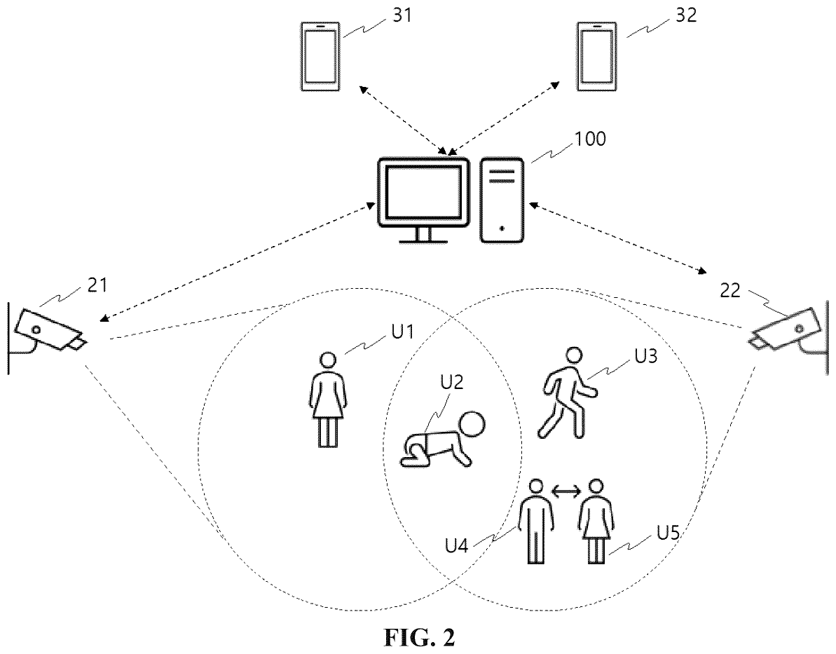

For example, as shown in FIG. 2, a monitoring apparatus 100 can receive video data including users U1, U2 from a camera 21. Subsequently, the monitoring apparatus 100 can detect users U1 and U2 included in the video data by the object detection unit 110 and generate identity data for each of the detected users U1 and U2. Here, the identity data may include at least one of a person's name, social security number, date of birth, phone number, gender, and identification number assigned according to a predetermined rule to distinguish a user. In the same manner, the object detection unit 110 may detect a person by analyzing video data received from a camera 22 and generate identity data of the person.

For example, the object detection unit 110 may acquire in advance facial photo information of respective users to distinguish their identities. Additionally, the object detection unit 110 may identify users' identities using predetermined identification marks attached to the respective users. For example, the identification marks may be predetermined marks such as number tags, name tags, or the like that can identify the users.

For example, the object detection unit 110 may identify users' identities using voice data. For this, the object detection unit 110 may receive voice data through a certain microphone. Additionally, the object detection unit 110 may further include an artificial neural network trained to identify persons' identities based on their voices. The object detection unit 110 may pre-train voice waveform data of respective users and acquire uttered waveforms of a capturing target user to identify the captured user's identity.

For example, each of the multiple cameras may be equipped with a front-directional microphone, and may acquire uttered sounds of an object facing a shooting camera. Subsequently, the identity of a captured user may be identified using a waveform of the acquired uttered sound of the object.

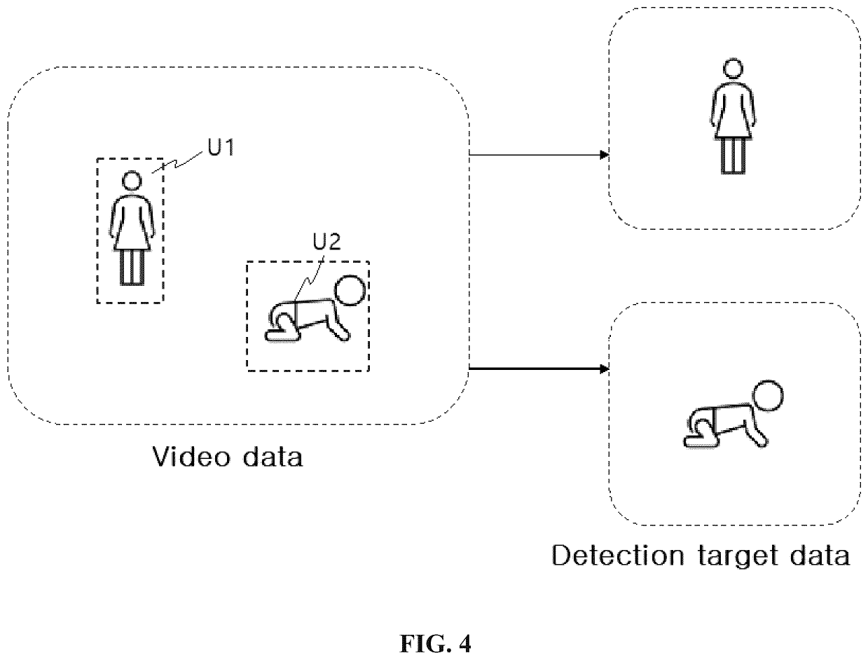

According to one embodiment, the object detection unit 110 may extract images of a persons detected as objects based on the coordinate data of one or more persons included in the video data to generate detection target data. Referring to FIG. 4, the object detection unit 110 may detect one or more persons from the video data and generate coordinate data of the detected one or more persons. Subsequently, the object detection unit 110 may extract images of the respective one or more persons from the video data based on the video data and coordinate data, and generate detection target data for each detected person using the extracted images.

According to one embodiment, the object detection unit 110 may input the detection target data into the second artificial neural network 113 to generate identity data of the persons included in the detection target data. For example, as shown in FIG. 4, if one piece of video data includes two persons, the object detection unit 110 may generate detection target data for each of the two persons and generate identity data for each person by inputting each detection target data into the second artificial neural network 113.

According to one embodiment, the object detection unit 110 may calculate locations of one or more persons based on the location information of one or more cameras and the coordinate data of one or more persons included in the video data to generate location data.

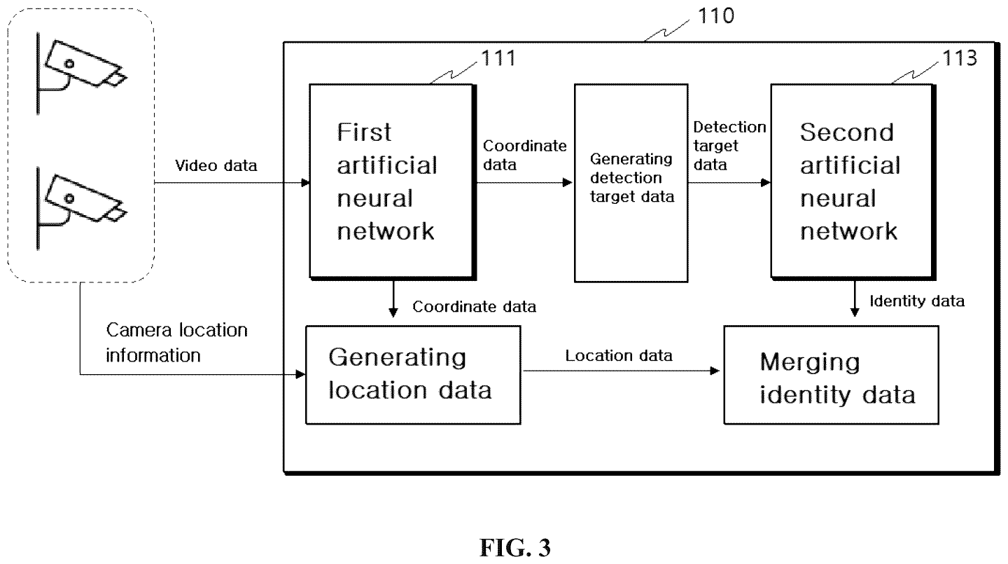

Referring to FIG. 3, the object detection unit 110 may receive camera location information from a camera unit. For example, the camera location information may include at least one of locations and heights where cameras are installed, left-right and up-down angles relative to the center of an area being photographed by a camera, and a focus value. Additionally, the object detection unit 110 may receive coordinate data in video data of persons included in the video data from the first artificial neural network 111. The object detection unit 110 may calculate values of actual locations of the persons included in the video data using the camera location information and coordinate data, and generate location data based on the calculated location values.

According to one embodiment, when persons detected in video data captured by multiple cameras are verified to be in a same location, the object detection unit 110 may determine these persons as one same person. Referring to FIG. 2, User U2 is included in areas captured by a camera 21 and a camera 22, and therefore, may be included in all video data generated by the respective cameras. The object detection unit 110 may calculate location data of User U2 included in video data received from the camera 21 and location data of User U2 included in video data received from the camera 22, and, when two locations are verified to be identical, determine the two users to be one same person.

According to one embodiment, the object detection unit 110 may merge multiple pieces of identity data for the persons, who have been determined as one same person, generated from the video data captured by multiple cameras and determine an identity of this person.

For example, the face of one same person may be captured differently depending on the shooting directions of respective cameras. For example, as shown in FIG. 2, the camera 21 may capture the back of User U2 while the camera 22 may capture the front of User U2. In such a case, when the second artificial neural network 113 analyzes video data received from the camera 21 and generate identification data, the identification may not be possible or identification value may be inaccurate.

On the other hand, when the second artificial neural network 113 analyzes video data received from the camera 22 and generates identification data, facial identification may be well performed, resulting in a relatively accurate identification value. Here, when the object detection unit 110 determines that the users captured in both pieces of video data are the same person, it may determine two pieces of identification data for two pieces of detection target data to be identical by merging the two pieces of identification data generated from the two pieces of video data. For example, the object detection unit 110 may select one with a higher probability among the two pieces of identification data including identification probabilities, for the persons who have been determined as one same person, in the two pieces of video data and determine it as identification data.

According to one embodiment, the behavior detection unit 120 may analyze behaviors of each of one or more detected persons based on the video data and the detection result and generate behavior type data. For example, behavior types may include at least one of nothing significant, aggressive behavior, sexual behavior, self-injurious behavior, disruptive behavior, and stereotyped behavior. In one example, behavior types may be subdivided into more specific categories. Here, “nothing significant’ may indicate behaviors that do not correspond to any of aggressive behavior, sexual behavior, self-injurious behavior, disruptive behavior, or stereotyped behavior.

For example, each of the above-described behavior types may be subdivided. For instance, aggressive behavior may be subdivided into hitting, scratching, spitting, etc.; self-injurious behavior may be subdivided into hitting oneself, biting, vomiting, etc.; sexual behavior may be subdivided into excessive physical contact with others, touching one's genitals, etc.; and disruptive behavior may be subdivided into yelling, crying, throwing tantrums, throwing objects, constant moving, slamming doors, making noise, etc. The behavior detection unit 120 may detect a person's behavior and classify the behavior into higher-level categories or subdivided lower-level categories to generate behavior type data. Here, the behavior types are merely examples for explanation and are not limited to these. The behavior types may be set differently depending on analysis purposes, implementation methods, or users.

According to one embodiment, the behavior detection unit 120 may include a third artificial neural network 121 trained to classify persons' behaviors included in video data into predetermined types. The third artificial neural network 121 may be trained using pieces of video data classified into behavior types as training data. Here, the third artificial neural network 121 may output probabilities of behavior types of a person included in the input video data or at least one of the behavior types. For example, the third artificial neural network 121 may receive video data and output probabilities of behavior types, such as ‘nothing significant=12%, aggressive behavior=53%, sexual behavior=23%, self-injurious behavior=32%, disruptive behavior=47%, stereotyped behavior=22%’. Alternatively, the third artificial neural network 121 may output information of a behavior type with the highest probability among the behavior types.

According to one embodiment, the behavior detection unit 120 may generate behavior type data of a person included in the detection target data based on the detection target data and identity data using the third artificial neural network 121. For example, the behavior detection unit 120 may generate behavior type data such as ‘User 1=nothing significant’ based on results output by the third artificial neural network 121 and the identity data.

According to one embodiment, the behavior detection unit 120 may merge two or more pieces of behavior type data for one same person captured by multiple cameras to generate behavior type data for this person.

For example, in a case when two cameras have captured one person, two pieces of video data may be generated, which results in two pieces of detection target data. In this case, the third artificial neural network 121 can analyze behavior types based on the two pieces of detection target data for this one same person. For example, the behavior detection unit 120 may analyze behavior types of the two pieces of detection target data, which are distinguished as (camera 1, user 1) and (camera 2, user 1), for the one same person using the third artificial neural network 121. This analysis may result in outputs such as (camera 1, user 1, nothing significant=65%) and (camera 2, user 1, disruptive behavior=54%).

When there are two or more behavior type results for one same person, the behavior detection unit 120 may select a behavior type with a higher probability or select a behavior type by weighting the probability of a specific behavior. For example, referring to selecting a behavior type with a higher probability, the behavior detection unit 120 may select ‘nothing significant’ with a higher probability among ‘nothing significant=65% and disruptive behavior=54%’ and generate behavior type data. For another example, if a weight of 30% is added to behavior types other than ‘nothing significant’, the weighted result of (nothing significant=65%, disruptive behavior=54%) may be (nothing significant=65%, disruptive behavior=70%). The behavior detection unit 120 may select ‘disruptive behavior’ to generate behavior type data. Here, the weight may be determined based on the importance or severity of behavior types.

According to one embodiment, the behavior detection unit 120 may analyze at least one of the number of occurrences, occurrence cycle, and duration of a specific behavior within a predetermined time based on behavior type data over time by identity. For example, there may be behavior types such as ‘attempting to converse, approaching, looking, light physical contact, etc.’ in addition to the behavior types described above. These behavior types are merely examples for explanation and are not limited to these. Additionally, behavior types may be set differently depending on analysis purposes, implementation methods, or users.

For example, the behavior detection unit 120 may store behavior type data over time and verify whether a specific behavior is repeated within a predetermined period. For example, if an analysis result of ‘attempting to converse=10’ is obtained for User 1 within one hour, the behavior detection unit 120 may determine that this specific behavior is repeated.

According to one embodiment, in a case when behaviors of a specific behavior type are detected to exceed a predetermined criterion, the behavior detection unit 120 may further include abnormality repetition data in behavior type data. For example, the behavior detection unit 120 may make ‘attempting to converse=10’ within one hour as a reference and, if such a behavior is repeated more than the reference, it may generate abnormality repetition data and include it in behavior type data.

According to one embodiment, when a person does a specific behavior, the behavior detection unit 120 may analyze the identity of other persons within a predetermined distance from this person based on the behavior type data over time by identity and the location data over time by identity and, in a case when behaviors of a specific behavior type exceeding a predetermined criterion are detected in the relationship with another person with a specific identity, the behavior detection unit 120 may further include abnormal relationship data in behavior type data.

For example, in a case when User 1 approaches User 2 within 1 meter and repeatedly attempts to converse with User 2, the behavior detection unit 120 may generate abnormal relationship data such as ‘User 1, User 2, attempting to converse=5 times’ and include it in behavior type data.

For example, an analysis over time may be used as a long-term problem situation scenario. For example, the ‘sociability’ may be determined based on interactions with others.

According to one embodiment, when a detection of a behavior of a specific type is verified based on behavior type data, the behavior detection unit 120 may store video data for a predetermined time based on the detection time. For example, if the behavior detection unit 120 detects a disruptive behavior of User 1, it may store video data for three minutes before and after the occurrence of the disruptive behavior.

According to one embodiment, the data transmission unit 130 may transmit monitoring data to one or more users predesignated according to specified criteria based on behavior type data. For example, the data transmission unit 130 may have information about data recipients for each behavior type and transmit data to designated recipients depending on detected behavior types. The recipient may be at least one of user themselves, guardians, designated family members, administrators, teachers, and medical professionals.

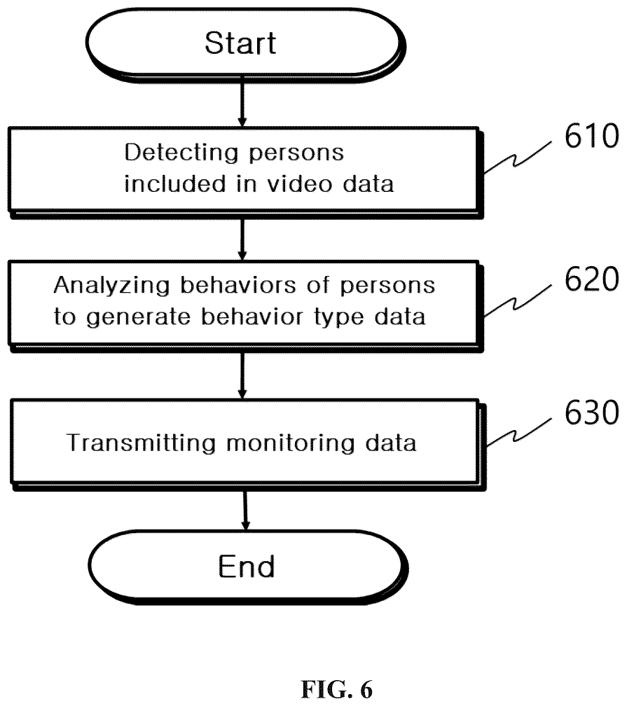

FIG. 6 is a flow diagram illustrating a monitoring method according to an embodiment.

According to one embodiment, a monitoring apparatus may receive video data generated from one or more cameras and detect one or more persons included in each piece of video data (610). Subsequently, the monitoring apparatus may analyze behaviors of each of the detected one or more persons based on the video data and the detection result and generate behavior type data (620), and transmit monitoring data to one or more users predesignated according to specified criteria based on the behavior type data (630).

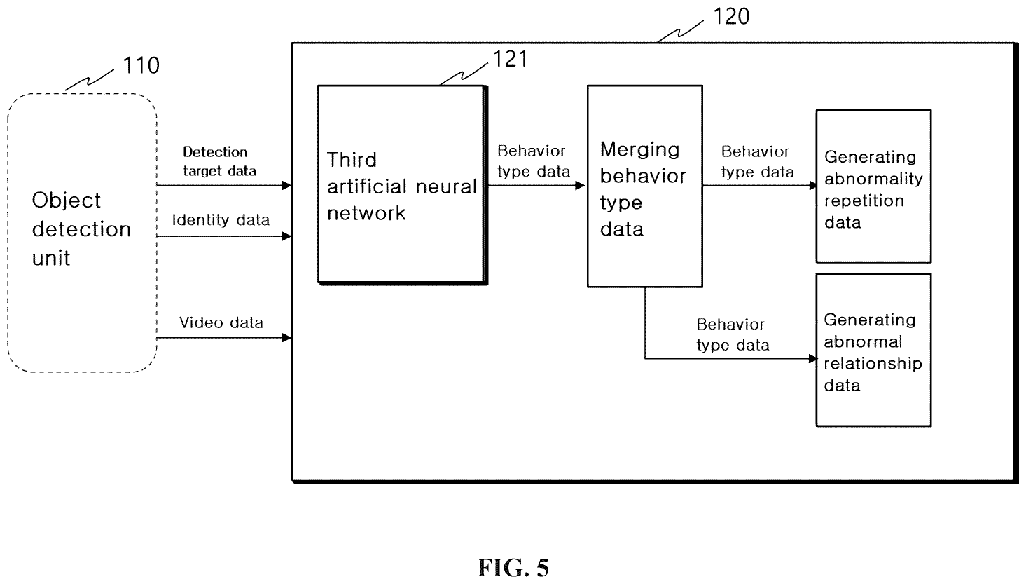

Descriptions identical to the descriptions regarding the embodiments described with reference to FIGS. 1 to 5 have been omitted in the embodiment of FIG. 6.

An aspect of the present disclosure can be implemented as computer-readable codes on a computer-readable recording medium. The codes and code segments that implement the program can be easily inferred by a computer programmer in the relevant field. The computer-readable recording medium may include all types of recording devices in which data readable by a computer system is stored. Examples of computer-readable recording media may include ROM, RAM, CD-ROM, magnetic tape, floppy disks, optical disks, etc. Additionally, the computer-readable recording medium can be distributed over networked computer systems, allowing the codes to be read and executed in a distributed manner.

Thus far, the present disclosure has been described with reference to its preferred embodiments. A person skilled in the art to which the present disclosure pertains will understand that the present disclosure can be implemented in modified forms without departing from its essential characteristics. Therefore, the scope of the present disclosure should not be limited to the above-described embodiments but should be construed to include various embodiments within the scope of the claims.

### LIST OF REFERENCE NUMBERS

100: Monitoring apparatus
110: Object detection unit
111: First artificial neural network
113: Second artificial neural network
120: Behavior detection unit
121: Third artificial neural network
130: Data transmission unit

What is claimed is:

1. A monitoring apparatus, comprising:
an object detection unit configured to receive video data generated from one or more cameras and to detect one or more persons included in each piece of video data;
a behavior detection unit configured to analyze behaviors of each of the one or more detected persons based on the video data and the detection result to generate behavior type data; and
a data transmission unit configured to transmit monitoring data to one or more predetermined users according to specified criteria based on the behavior type data.

2. The monitoring apparatus of claim 1, wherein the object detection unit:
generates coordinate data of the one or more persons included in the video data using a first artificial neural network trained to classify a person as an object and detect the location of the object; and
generates identity data for each of the one or more detected persons using a second artificial neural network trained to recognize the face of the person and identify the identity.

3. The monitoring apparatus of claim 2, wherein the object detection unit:
extracts images of the person classified as an object based on the coordinate data of the one or more persons included in the video data to generate detection target data; and
generates identity data of the person included in the detection target data by inputting the detection target data into the second artificial neural network.

4. The monitoring apparatus of claim 2, wherein the object detection unit:
generates location data by calculating the locations of one or more persons based on the location information of the one or more cameras and the coordinate data of the one or more persons included in the video data;
determines the persons as one same person if the persons are detected at the same location in the video data captured by multiple cameras; and
determines the identity of the one same person by merging multiple pieces of identity data generated from the video data captured by the multiple cameras for the person determined as one same person.

5. The monitoring apparatus of claim 3, wherein the behavior detection unit:
includes a third artificial neural network trained to classify behaviors of persons included in the video data into predetermined types; and
generates behavior type data for a person included in the detection target data based on the detection target data and the identity data using the third artificial neural network.

6. The monitoring apparatus of claim 5, wherein the behavior detection unit:
merges two or more pieces of behavior type data for the one same person captured by multiple cameras to generate behavior type data for the one same person.

7. The monitoring apparatus of claim 5, wherein the behavior detection unit:
analyzes at least one of the number of occurrences, occurrence cycle, and duration of a specific behavior within a predetermined time based on the behavior type data over time by identity; and
further includes abnormality repetition data in the behavior type data if any behaviors exceeding a predetermined criterion for each behavior type are detected.

8. The monitoring apparatus of claim 7, wherein the behavior detection unit:
analyzes the identity of other persons within a predetermined distance during a specific behavior based on the behavior type data over time by identity and the location data over time by identity; and
further includes abnormal relationship data in the behavior type data if any behavior exceeding a predetermined criterion for each specific behavior type is detected in relation to a person with a specific identity.

9. The monitoring apparatus of claim 5, wherein the behavior detection unit:
stores video data of a predetermined time period based on the detection time when a specific type of behavior is detected based on the behavior type data.

10. A monitoring method executed by a monitoring apparatus, comprising:
an object detection step of receiving video data generated from one or more cameras and detecting one or more persons included in each piece of video data;
a behavior detection step of analyzing behaviors of each of the one or more detected persons based on the video data and the detection result to generate behavior type data; and
a data transmission step of transmitting monitoring data to one or more users predesignated according to specified criteria based on the behavior type data.
